(19) United States
(12) Patent Application Publication
(10) Pub. No.: US 2013/0258705 A1
(43) Pub. Date: Oct. 3, 2013

(54) FRONT-LIGHT MODULE AND LIGHT SOURCE MODULATION APPARATUS THEREOF

(71) Applicant: E INK HOLDINGS INC., Hsinchu (TW)

(72) Inventors: Yu-Nan PAO, HSINCHU (TW); I-Jeng CHEN, HSINCHU (TW); Chin-Ju HSU, HSINCHU (TW); Hsin-Tao HUANG, HSINCHU (TW); Yu-Nan TSAO, HSINCHU (TW)

(73) Assignee: E INK HOLDINGS INC., HSINCHU (TW)

(21) Appl. No.: 13/749,709

(22) Filed: Jan. 25, 2013

Related U.S. Application Data
(60) Provisional application No. 61/619,432, filed on Apr. 3, 2012.

(30) Foreign Application Priority Data
Oct. 8, 2012 (TW) 101137158

(51) Int. Cl. F21V 8/00

(52) U.S. Cl. CPC G02B 6/0023
USPC 362/603; 362/608

(57) ABSTRACT

A front-light module includes at least one point light source, a light source modulation apparatus and a light guide plate. The light source modulation apparatus includes a body and a plurality of uniform illumination microstructures. The body includes a light incident surface and a light emission surface. The point light source is disposed beside the light incident surface, and the light emission surface is opposite to the light incident surface. The uniform illumination microstructures are disposed on the light emission surface of the body. Each uniform illumination microstructure is arc-shaped.

### RELATED APPLICATIONS

This application claims the priority benefit of provisional application Ser. No. 61/619,432, filed Apr. 3, 2012, the full disclosure of which is incorporated herein by reference. This application also claims the priority benefit of Taiwan application serial no. 101137158, filed Oct. 8, 2012, the full disclosure of which is incorporated herein by reference.

### BACKGROUND

1. Technical Field

Embodiments of the present invention relate to a front-light module. More particularly, embodiments of the present invention relate to a front-light module and a light source modulation apparatus thereof.

2. Description of Related Art

Currently, most electronic book readers employ a reflective display that utilizes natural light, such as sunlight, to provide illumination. Because the brightness of a reflective display is completely reliant on ambient light, once an electronic book reader utilizing the reflective display is placed in a dark environment, the reflective display is rendered unusable. Therefore, a front-light module is disposed on the reflective display, so as to provide additional illumination to the reflective display when there is no or a low level of illumination from ambient light.

A typical front-light module includes a plurality of light sources and a light guide plate. The light propagates in the light guide plate according to the total internal reflection, and the light guide plate utilizes the microstructures thereon to interfere with the total internal reflection total internal reflection, thereby guiding the light to propagate out of the light guide plate. The intensity of the arrangement of the microstructures is used to control the uniformity of the light propagating out of the light guide plate. Two types of light guide plates have been developed.

One type of light guide plate involves disposing numerous dot microstructures on the light guide plate. These dot microstructures can interfere with total internal reflection by scattering light. However, the S/N ratio is quite low when a display employs this type of light guide plate. Another type of light guide plate involves disposing numerous V-grooves on the light guide plate. The V-grooves can redirect light in the light guide plate, thereby interfering with the total internal reflection.

Compared with a light guide plate with dot microstructures, the directivity of the light emitted from the light guide plate with V-grooves is better and the light field is easier to be controlled. However, because of the high directivity, the reflective directions of different light beams are consistent, and if the light source is a point light source such as an LED (light-emitting diode), light beams emitted from each LED will form stripe-like patterns after propagating through the light guide plate.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

One aspect of the present invention is to provide a light source modulation apparatus that makes numerous point light sources look like a linear or planar light source with uniform illumination distribution and various emitting directions, so as to eliminate stripe-like patterns in the light guide plate.

In accordance with one embodiment of the present invention, a light source modulation apparatus includes a body and a plurality of uniform illumination microstructures. The body includes a light incident surface and a light emission surface opposite to the light incident surface. The light incident surface is used for receiving light from at least one point light source. The uniform illumination microstructures are disposed on the light emission surface of the body. Each of the uniform illumination microstructures is arc-shaped.

Another aspect of the present invention is to provide a front-light module. In accordance with one embodiment of the present invention, a front-light module includes at least one point light source, a light source modulation apparatus and a light guide plate. The light source modulation apparatus includes a body and a plurality of uniform illumination microstructures. The body includes a light incident surface and a light emission surface opposite to the light incident surface. The point light source is disposed beside the light incident surface. The uniform illumination microstructures are disposed on the light emission surface of the body. Each of the uniform illumination microstructures is arc-shaped. The light guide plate faces the light emission surface of the body of the light source modulation apparatus.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a light source modulation apparatus in accordance with one embodiment of the present invention;

FIG. 2 is a light path diagram of the light source modulation apparatus in FIG. 1;

FIG. 3 is a partial top view of the light source modulation apparatus in FIG. 1;

FIG. 4 is a partial top view of the light source modulation apparatus in accordance with another embodiment of the present invention;

FIG. 5 is a light path diagram of a light diffusing microstructure in accordance with one embodiment of the present invention;

FIG. 6 is a partial top view of the light source modulation apparatus in accordance with another embodiment of the present invention;

FIG. 7 is a partial top view of the light source modulation apparatus in accordance with yet another embodiment of the present invention;

FIG. 8 is a partial top view of the light source modulation apparatus in accordance with yet another embodiment of the present invention;

FIG. 9 is a perspective view of the light source modulation apparatus in accordance with yet another embodiment of the present invention;

FIG. 10 is a perspective view of a front-light module in accordance with one embodiment of the present invention; and

FIG. 11 is a perspective view of a display apparatus in accordance with one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

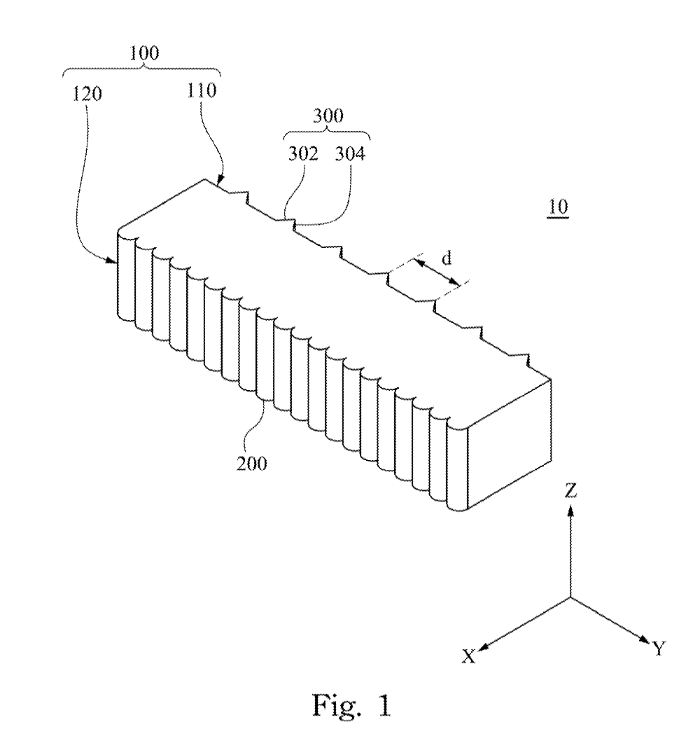

FIG. 1 is a perspective view of a light source modulation apparatus 10 in accordance with one embodiment of the present invention. As shown in FIG. 1, the light source modulation apparatus 10 includes a body 100 and a plurality of uniform illumination microstructures 200. The body 100 includes a light incident surface 110 and a light emission surface 120 opposite to the light incident surface 110. The uniform illumination microstructures 200 are disposed on the light emission surface 120 of the body 100. Each of the uniform illumination microstructures 200 is arc-shaped.

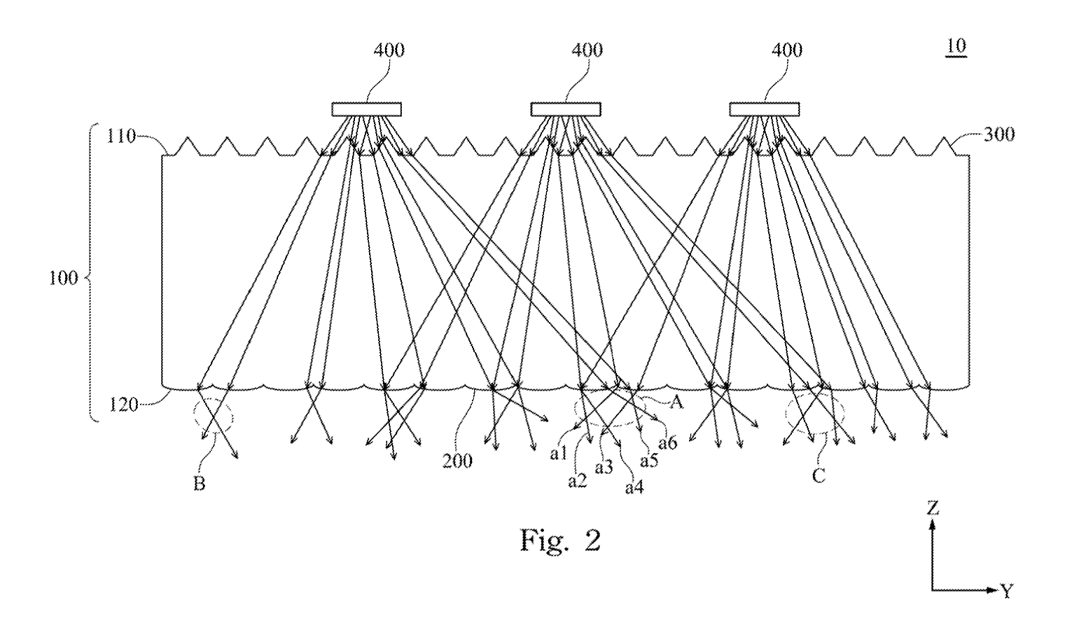

FIG. 2 is a light path diagram of the light source modulation apparatus 10 in FIG. 1. In FIG. 2, the light incident surface 110 is used for receiving light from at least one point light source 400. The light propagates in the body 100 and arrives at the light emission surface 120. Because the uniform illumination microstructures 200 are arc-shaped, they can uniformly distribute the illumination and differentiate the directions of the light beams.

Specifically, as shown in area A in FIG. 2, because the uniform illumination microstructures 200 are arc-shaped, the normal lines of different positions on the surface thereof along the y direction are not parallel to each other, and therefore, the emission angles between different light beams and the uniform illumination microstructure 200 are different. Accordingly, light beams a1, a2, a3, a4, a5 and a6 leaving from different positions on the uniform illumination microstructure 200 propagate along different directions, instead of along one single specific direction, so that the directions of the light beams a1, a2, a3, a4, a5 and a6 can be differentiated. For example, in area A, the light beams a1 and a3 propagate leftward, and the light beams a2, a4, a5 and a6 propagate rightward. Similarly, in areas B and C, some light beams propagate leftward, and some propagate rightward. Because each position on the light emission surface 120 along the y direction emits light beams in different directions. If viewed from the light emission surface 120, the observer will see uniform light distributing like a linear or planar light source, rather than seeing numerous separated point light sources 400. Therefore, the uniform illumination microstructure 200 can make numerous separated point light sources 400 look like a linear or planar light source with uniform illumination distribution and various emitting directions.

Referring back to FIG. 1, the uniform illumination microstructures 200 are continuously connected along a lengthwise direction of the body 100. Specifically, the lengthwise direction of the body 100 is parallel to the y direction shown in FIG. 1, and the uniform illumination microstructures 200 are continuously connected along the y direction.

It is noted that “continuously connected” refers to a configuration in which two adjacent structures are immediately connected without gaps (for example, two adjacent uniform illumination microstructures 200 may be immediately connected arc-shaped surfaces), and there is no plane between the adjacent uniform illumination microstructures 200. Because these uniform illumination microstructures 200 are continuously connected without any plane formed therebetween, the directions of the normal lines of adjacent positions on the light emission surface 120 along the y direction are always different, so as to facilitate differentiating the directions of the light beams.

In some embodiments, the uniform illumination microstructures 200 cover the whole light emission surface 120 of the body 100. In other words, the entirety of the light emission surface 120 is not exposed and is covered by the uniform illumination microstructures 200.

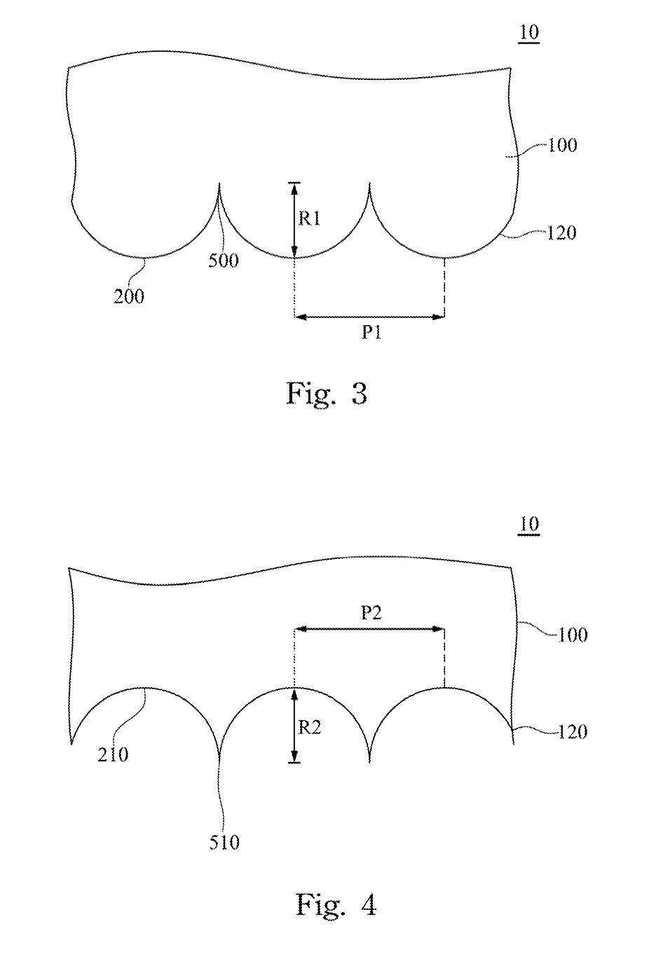

FIG. 3 is a partial top view of the light source modulation apparatus 10 in FIG. 1. As shown in FIG. 3, the uniform illumination microstructures 200 are protruded on the light emission surface 120 of the body 100. Specifically, each of the uniform illumination microstructure 200 is a convex surface protruded on the light emission surface 120. Two adjacent uniform illumination microstructures 200 are connected by a joint part 500. The joint part 500 is a curvature inflection interface between two adjacent uniform illumination microstructures 200. The uniform illumination microstructures 200 can be continuously connected by the joint parts 500.

Each of the uniform illumination microstructures 200 includes a curvature radius R1. Two adjacent uniform illumination microstructures 200 define a pitch P1. The pitch P1 can be defined as the distance between the vertexes of the adjacent uniform illumination microstructures 200 in top view. In some embodiments, the curvature radius R1 is about 25 μm, the pitch P1 is about 45 μm, and the thickness of the body 100 is about 13 mm. Based on the aforementioned size, the uniform illumination microstructures 200 can uniformly distribute the illumination and differentiate the directions of the light beams more effectively. It is noted that the thickness of the body 100 refers to the distance to between the light incident surface 110 (See FIG. 1) and the light emission surface 120.

FIG. 4 is a partial top view of the light source modulation apparatus 10 in accordance with another embodiment of the present invention. This embodiment is similar to the embodiment shown in FIG. 3, and the main difference is that the uniform illumination microstructures 210 in this embodiment differ from the uniform illumination microstructures 200 in FIG. 3. In this embodiment, the uniform illumination microstructures 210 are concave on the light emission surface 120 of the body 100. Specifically, each of the uniform illumination microstructures 210 is a concave surface that is extended inwardly on the light emission surface 120. Two adjacent uniform illumination microstructures 210 are connected by a joint part 510. The joint part 510 is a curvature inflection interface between two adjacent uniform illumination microstructures 210. The uniform illumination microstructures 210 can be continuously connected by the joint parts 510.

Each of the uniform illumination microstructure 210 includes a curvature radius R2. Two adjacent uniform illumination microstructures 210 define a pitch P2. The pitch P2 can be defined as the distance between the vertexes of the adjacent uniform illumination microstructures 210 in top view. In some embodiments, the curvature radius R2 is about 25 μm, the pitch P2 is about 45 μm, and the thickness of the body 100 is about 13 mm. Based on the aforementioned size, the uniform illumination microstructures 210 can uniformly distribute the illumination and differentiate the directions of the light beams more effectively.

Referring back to FIG. 1, in some embodiments, the light source modulation apparatus 10 further includes a plurality of light diffusing microstructures 300 disposed on the light incident surface 110 of the body 100. In this embodiment, each of the light diffusing microstructures 300 is a polygonal prism protruded on the light incident surface 110 of the body 100. Specifically, each of the light diffusing microstructures 300 may include a first slanted surface 302 and a second slanted surface 304. The first slanted surface 302 and the second slanted surface 304 are connected to construct a triangular prism.

In some embodiments, the light diffusing microstructures 300 are arranged along the lengthwise direction of the body 100 and spaced apart. In other words, the light diffusing microstructures 300 are arranged along the direction parallel to the y direction in FIG. 1. Further, two adjacent light diffusing microstructures 300 define an interval d. The interval d is long enough to space apart the light diffusing microstructures 300. It is noted that the feature “the light diffusing microstructures 300 are spaced apart” refers to the configuration in which the first slanted surface 302 and the second slanted surface 304 of any light diffusing microstructure 300 do not connect with the first slanted surfaces 302 and the second slanted surfaces 304 of another light diffusing microstructures 300.

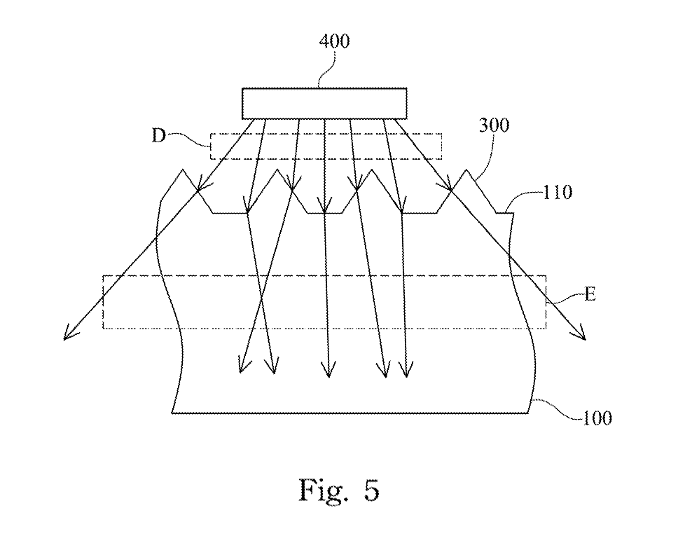

FIG. 5 is a light path diagram of the light diffusing microstructure 300 in accordance with one embodiment of the present invention. As shown in FIG. 5, the point light source 400 emits numerous light beams toward the light incident surface 110 of the body 100. These light beams construct a first light beam surface D. When the light beams within the first light beam surface D arrive at the light diffusing microstructures 300 on the light incident surface 110, they are refracted due to the difference between the refractive indexes, and they are further redirected outwardly because the shape of the light diffusing microstructures 300 modifies the incident angles and the refraction angles, so that the first light beam surface D can be expanded into a broader second light beam surface E. Specifically, the light beams emitted from the point light source 400 diffuse naturally. That is, even when there are no light diffusing microstructures 300 on the light incident surface 110, the light beams propagating into the body 100 nevertheless diffuse. But because the light diffusing microstructures 300 modify the incident angles and the refraction angles when the light beams arrives at the body 100, the light beams can be further refracted outwardly. Therefore, in addition to the natural diffusion of the light emitted from the point light source 400, the light diffusing microstructures 300 can further expand the emitting range.

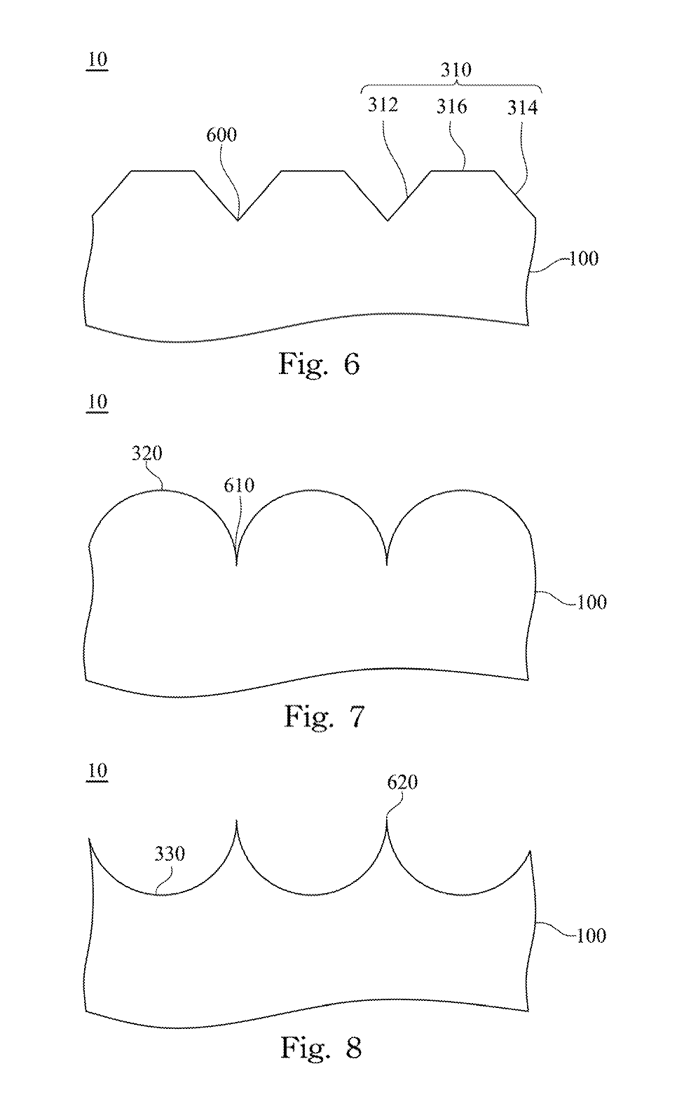

FIG. 6 is a partial top view of the light source modulation apparatus 10 in accordance with another embodiment of the present invention. The main difference between this embodiment and the embodiment shown in FIG. 1 is that the light diffusing microstructures 310 in this embodiment differ from the light diffusing microstructures 300 in FIG. 1. In this embodiment, the light diffusing microstructures 310 are continuously connected along the lengthwise direction of the body 100, and each of the light diffusing microstructures 310 is a trapezoidal prism, and not a triangular prism as in the case of the embodiment shown in FIG. 1.

Specifically, each of the light diffusing microstructures 310 may include a first slanted surface 312, a second slanted surface 314 and a top surface 316. The opposite sides of the top surface 316 are respectively connected to the first slanted surface 312 and the second slanted surface 314, thereby constructing the trapezoidal prism. Two adjacent light diffusing microstructures 310 are connected by a joint part 600. The joint part 600 is a curvature inflection interface between two adjacent light diffusing microstructures 310. The light diffusing microstructures 310 can be continuously connected by the joint parts 600.

FIG. 7 is a partial top view of the light source modulation apparatus 10 in accordance with yet another embodiment of the present invention. The main difference between this embodiment and the embodiment shown in FIG. 6 is that the light diffusing microstructures 320 in this embodiment differ from the light diffusing microstructures 310 in FIG. 6. In this embodiment, each of the light diffusing microstructures 320 is arc-shaped. Specifically, each of the light diffusing microstructures 320 is a convex surface protruded on the body 100. Two adjacent light diffusing microstructures 320 are connected by a joint part 610. The joint part 610 is a curvature inflection interface between two adjacent light diffusing microstructures 320. The light diffusing microstructures 320 can be continuously connected by the joint parts 610.

FIG. 8 is a partial top view of the light source modulation apparatus 10 in accordance with yet another embodiment of the present invention. The main difference between this embodiment and the embodiment shown in FIG. 7 is that the light diffusing microstructures 330 in this embodiment differ from the light diffusing microstructures 320 in FIG. 7. In this embodiment, each of the light diffusing microstructures 330 is a concave surface that is extended inwardly on the body 100. Two adjacent light diffusing microstructures 330 are connected by a joint part 620. The joint part 620 is a curvature inflection interface between two adjacent light diffusing microstructures 330. The light diffusing microstructures 330 can be continuously connected by the joint parts 620.

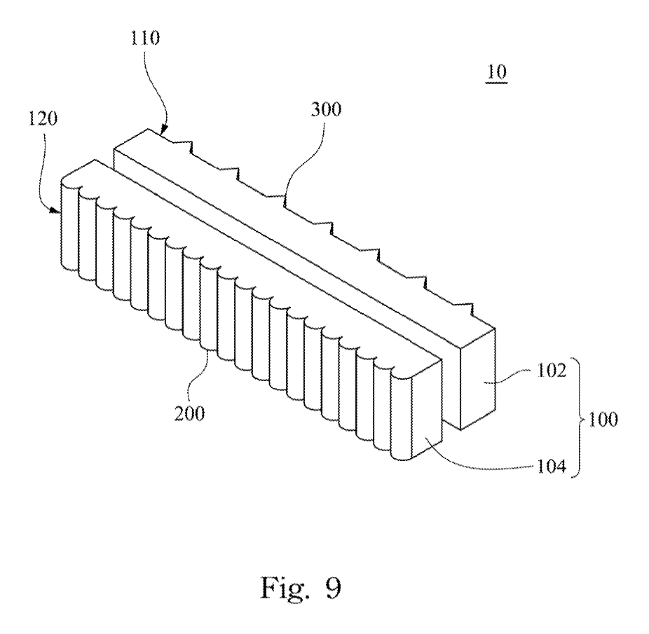

FIG. 9 is a perspective view of the light source modulation apparatus 10 in accordance with yet another embodiment of the present invention. As shown in FIG. 9, the body 100 includes a first sub-body 102 and a second sub-body 104. The second sub-body 104 is spaced apart from the first sub-body 102. The light incident surface 110 is located on one side of the first sub-body 102 opposite to the second sub-body 104. The light emission surface 120 is located on one side of the second sub-body 104 opposite to the first sub-body 102. In this embodiment, the first sub-body 102 utilizes the light diffusing microstructures 300 on the light incident surface 110 for expanding the emitting range, and the second sub-body 104 receives the light beams from the first sub-body 102 and utilizes the uniform illumination microstructures 200 to differentiate the directions of the light beams, so as to uniformly distribute the illumination and uniformly differentiate the directions of the light beams. In this embodiment, the second sub-body 104 is disposed exactly behind the first sub-body 102 to receive the light.

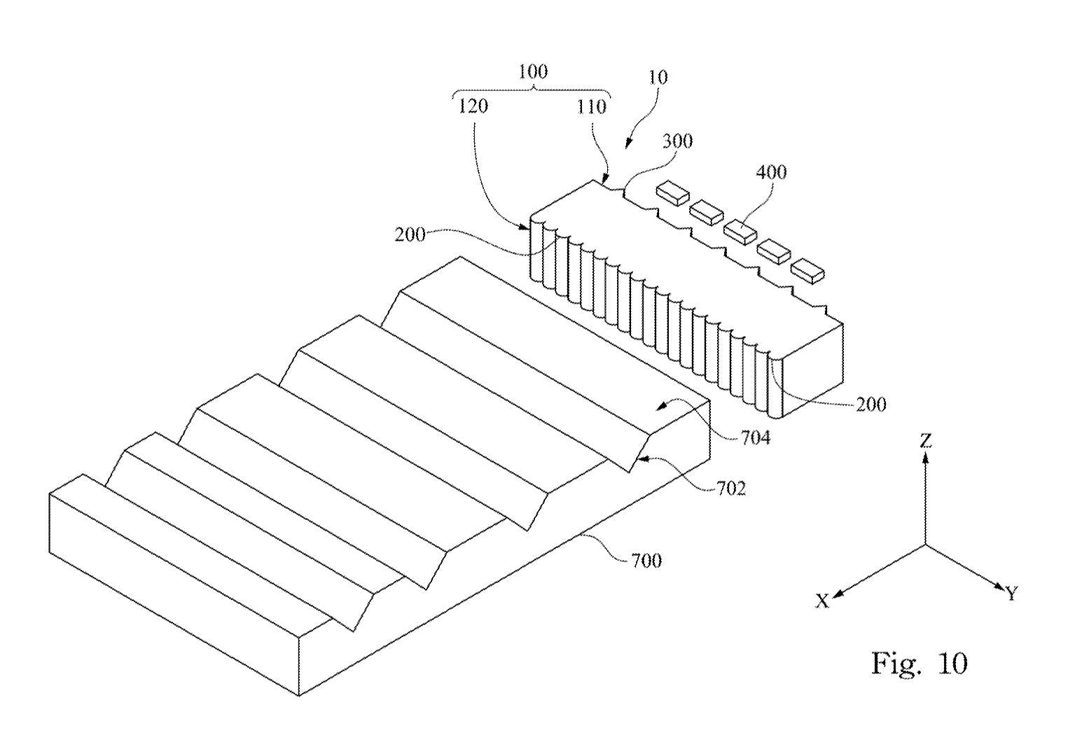

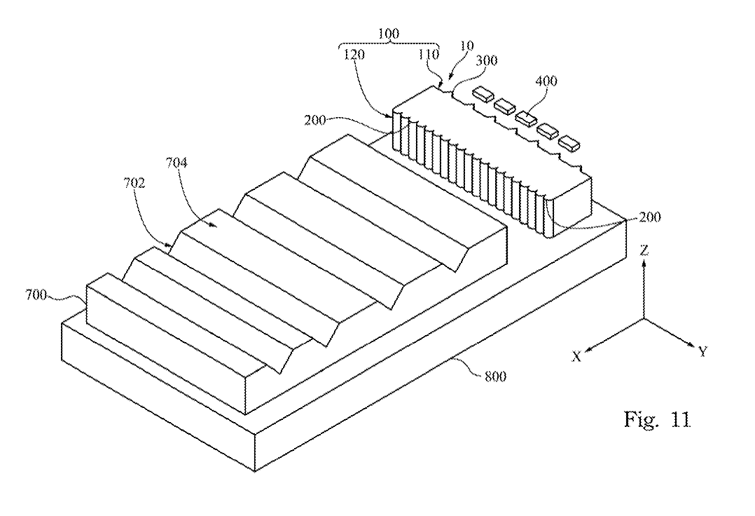

FIG. 10 is a perspective view of a front-light module in accordance with one embodiment of the present invention. As shown in FIG. 10, the front-light module includes at least one point light source 400, a light source modulation apparatus 10 and a light guide plate 700. The light source modulation apparatus 10 includes a body 100 and a plurality of uniform illumination microstructures 200. The body 100 includes a light incident surface 110 and a light emission surface 120 opposite to the light incident surface 110 The point light source 400 is disposed beside the light incident surface 110. The light guide plate 700 faces the light emission surface 120 of the body 100. The uniform illumination microstructures 200 are disposed on the light emission surface 120 of the body 100. Each of the uniform illumination microstructures 200 is arc-shaped.

As shown in FIG. 2 and with reference to the related description provided above, because the uniform illumination microstructures 200 are arc-shaped, they can uniformly distribute the illumination and differentiate the directions of the light beams from the point light sources 400. If viewed from the light emission surface 120 of the light source modulation apparatus 10, the observer will see uniform light distributing like a linear or planar light source, rather than seeing numerous separated point light sources 400. Therefore, the uniform illumination microstructure 200 can make numerous separated point light sources 400 look like a linear or planar light source with uniform illumination distribution and various emitting directions. Even though a plurality of grooves 702 are disposed on a surface 704 of the light guide plate 700, there is still no stripe-like pattern shown on the light guide plate 700.

In some embodiments, the point light source 400 can be, but is not limited to being, an LED. In some embodiments, the light source modulation apparatus 10 is a light transmissive object with a refractive index ranging from about 1.4 to about 1.6. In some embodiments, the light source modulation apparatus 10 can be formed by light transmissive plastic material or glass. The light transmissive plastic material can be, but is not limited to being, PMMA (Polymethylmethacrylate) or PC (Polycarbonnate). In some embodiments, each of the grooves 702 can be, but is not limited to being, a V-shaped groove.

FIG. 11 is a perspective view of a display apparatus in accordance with one embodiment of the present invention. As shown in FIG. 11, the display apparatus includes at least one point light source 400, a light source modulation apparatus 10, a light guide plate 700 and a reflective display panel 800. The light guide plate 700 is disposed on a display surface of the reflective display panel 800 for providing light to the reflective display panel 800, so that the reflective display panel 800 can still work when the level of the ambient light is low or when there is no ambient light. In some embodiments, the reflective display panel 800 can be, but is not limited to being, an LCD (liquid crystal display) or an EPD (electrophoretic display).

It is noted that a description such as “feature A is disposed on feature B” in this specification not only refers to an embodiment where feature A directly contacts feature B, but also refers to an embodiment where an additional feature C may be disposed between feature A and feature B.

Although the present invention has been described in considerable detail with reference to certain embodiments thereof, other embodiments are possible. Therefore, the spirit and scope of the appended claims should not he limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light source modulation apparatus, comprising:
a body having a light incident surface and a light emission surface opposite to the light incident surface, wherein the light incident surface is used for receiving light from at least one point light source; and
a plurality of uniform illumination microstructures disposed on the light emission surface of the body, wherein each of the uniform illumination microstructures is arc-shaped.

2. The light source modulation apparatus of claim 1, wherein the uniform illumination microstructures are continuously connected along a lengthwise direction of the body.

3. The light source modulation apparatus of claim 2, wherein the uniform illumination microstructures cover the whole light emission surface of the body.

4. The light source modulation apparatus of claim 1, wherein the uniform illumination microstructures are protruded on the light emission surface of the body.

5. The light source modulation apparatus of claim 1, wherein the uniform illumination microstructures are concave on the light emission surface of the body.

6. The light source modulation apparatus of claim 1, further comprising:
a plurality of light diffusing microstructures disposed on the light incident surface of the body for expanding an emitting range of the point light source.

7. The light source modulation apparatus of claim 1, wherein the body comprises:
a first sub-body; and
a second sub-body spaced apart from the first sub-body, wherein the light incident surface is located on one side of the first sub-body opposite to the second sub-body, and the light emission surface is located on one side of the second sub-body opposite to the first sub-body.

8. A front-light module, comprising:
at least one point light source;
a light source modulation apparatus comprising:
a body having a light incident surface and a light emission surface opposite to the light incident surface, wherein the point light source is disposed beside the light incident surface; and
a plurality of uniform illumination microstructures disposed on the light emission surface of the body, wherein each of the uniform illumination microstructures is arc-shaped; and
a light guide plate facing to the light emission surface of the body of the light source modulation apparatus.

9. The front-light module of claim 8, wherein the light guide plate comprises a plurality of grooves disposed on a surface of the light guide plate.

10. The front-light module of claim 8, wherein the at least one point light source is plural, and the point light sources are arranged along a lengthwise direction of the body of the light source modulation apparatus.

11. The front-light module of claim 10, wherein the uniform illumination microstructures are continuously connected along the lengthwise direction of the body.

12. The front-light module of claim 11, wherein the uniform illumination microstructures cover the whole light emission surface of the body.

13. The front-light module of claim 8, wherein the uniform illumination microstructures are protruded on the light emission surface of the body.

14. The front-light module of claim 8, wherein the uniform illumination microstructures are concave on the light emission surface of the body.

15. The front-light module of claim 8, further comprising:
a plurality of light diffusing microstructures disposed on the light incident surface of the body for expanding an emitting range of the point light source.

16. The front-light module of claim 8, wherein the body comprises:
a first sub-body; and
a second sub-body spaced apart from the first sub-body, wherein the light incident surface is located on one side of the first sub-body opposite to the second sub-body, and the light emission surface is located on one side of the second sub-body opposite to the first sub-body.
